(19) United States
(12) Patent Application Publication
(10) Pub. No.: US 2007/0272095 A1
(43) Pub. Date: Nov. 29, 2007

(54) Plastic bottle folding compacter / crusher

(76) Inventor: George E. Mainwaring, Anza, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/441,329

(22) Filed: May 26, 2006

(51) Int. Cl. B30B 1/26

(52) U.S. Cl. 100/292

(57) ABSTRACT

A plastic bottle compacting device is disclosed that provides for reducing the size of an empty plastic bottle by folding the empty bottle around itself. The plastic bottle compacting device can be mounted on a wall, cabinet table or desk to hold the device in position while it is being used. After the bottle is folded, a band, tape or strap is wrapped around the compacted bottle to maintain the compacted shape of the bottle. The apparatus includes holding pins to hold the empty bottle in a vertical or horizontal relationship and a rotating arm that folds the empty bottle upon itself. In another embodiment an empty bottle is placed in the holding pins and manually wrapped into a cylinder around the holding pins. After the bottle is crushed it is withdrawn from the holder wrapped and stored in a recycling container for reclaiming.

### FIELD OF THE INVENTION

This invention relates to a plastic bottle crusher. More particularly, the present invention relates to a crusher for plastic bottles where the crushing in performed by rotating the plastic bottle around its vertical length. After the bottle is crushed a band or tape may be placed around the bottle to maintain the bottle in a crushed orientation.

### BACKGROUND OF THE INVENTION

The need to recycle products such as paper, metals, plastics and glass continues to be a priority. Most states place a recycling fee on these materials to ensure that they are recycled instead of being thrown away with other trash. One problem with recycling materials is the volume of air that is inside an empty container. A number of patents have been issued that address compressing or shredding plastic container to reduce the amount of air that is inside the plastic container.

U.S. Pat. No. 5,448,946 issued to Laux on Sep. 12, 1995 and U.S. Pat. No. 2,638,957 issued May 19, 1953 to Danielson both disclose a bottle compacting apparatus. These patents disclose a rack and pinion mechanism that compacts the bottle along the length of the bottle. While these patents disclose a compacting mechanism, the mechanism does not compact the bottle by rotating the bottle around itself and the apparatus is large in size requiring a significant amount of space for using the device. The devices further are not intended for mounting on a wall to keep them out of the way and also ready to use.

U.S. Pat. No. 3,934,498 issued to Hochanadel on Jan. 27, 1976 discloses a compacter for compacting objects such as cans and the like. This patent discloses a device that rotates cans and other objects, such as plastic bottles, along their elongated axis. This causes the walls of the can or bottle to collapse and the can is be twisted down upon itself. While this patent discloses a compacting mechanism, the mechanism does not compact the bottle by rotating the bottle around itself and the apparatus is large in size requiring a significant amount of space for using the device. The device is further not intended for mounting on a wall and requires electricity to power the rotating mechanism.

U.S. Pat. No. 5,102,057 issued to Ellis, III on Apr. 7, 1992, discloses an automatic plastic crusher apparatus. This patent discloses an apparatus with powered twisting drums. When a plastic bottle comes in contact with the conical drums the bottle is twisted around its elongated vertical axis and is spun into a narrower elongated shape.

What is needed is a plastic bottle crusher that rotates the bottle around it length to wrap the bottle onto itself. The ideal apparatus would be simple to operate and be mountable on a table, cabinet or wall. The apparatus would further utilize a banding, taping or wrapping mechanism that keeps the bottles in a wound configuration to reduce the amount of storage space that is needed for the empty bottles. The proposed apparatus provides this solution with a wall, cabinet or table mountable device that wraps an empty bottle upon itself and it can further be maintained in the wrapped shape with a band, tape or other similar restraining mechanism.

### BRIEF SUMMARY OF THE INVENTION

It is an object of the plastic bottle folding compacter to provide a plastic bottle compacter that folds or rotates a plastic bottle around its length. This allows the bottle to be compacted, turning the bottle into approximately the shape of a small cylinder. This shape reduces the overall volume of the bottle to less than one fourth of its empty volume. The air from inside the bottle is pushed out of the empty bottle as it is folded.

It is an object of the plastic bottle folding compacter to allow the compacter to be mounted on a wall, cabinet or table. Mounting the compacter on a wall allows the compacter to be within easy reach and does not use counter space. Mounting the compacter on a counter or table is ideal when it is difficult to ensure that the wall mounting location is sufficiently secure to not damage the wall or pull the compacter out of the wall when it is being used.

It is another object of the plastic bottle folding compacter to provide a compacter that does not require electricity for operation. Since the compacter does not require electricity it can be located and operated in nearly any location including a park setting where people are likely to discard an empty bottle.

It is another object of the compacter to provide bands, tape or other wrapping agents that ensure that the folded bottle will maintain a compacted orientation after it has been folded. The band, or tape keeps the bottle in a tight cylinder ensuring that the small size is maintained after the bottle is stored for recycling. The smaller size further allows for the storage of a greater number of bottles prior to taking the bottles for recycling.

It is still another object of the plastic bottle folding compacter to provide the compacter with a rotatable arm where the user articulates the arm to fold the bottle into itself. The handle can rotate the bottle onto itself, or the handle can rotate the bottle around a mandrel to rotate the bottle onto itself. The end of the handle has a free rotating spindle to allow the spindle to rotate. In another embodiment the arm is eliminated and the operator can place an empty bottle into the holder and manually rotate the empty bottle into itself.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a front view of the plastic bottle crusher.

FIG. 2 shows a top view of the plastic bottle crusher from FIG. 1.

FIG. 3 shows a front view of the plastic bottle crusher from FIG. 1 with a bottle installed in the crusher.

FIG. 3A shows a front view of the plastic bottle crusher from FIG. 3 with the bottle in the initial stages of being crushed.

FIG. 3B shows a front view of the plastic bottle crusher from FIG. 3 with the bottle nearly completely crushed.

FIG. 4 shows a second alternate embodiment of the plastic bottle crusher shown with the bottle placed inside the bottle crusher.

FIG. 5 shows a top view of the plastic bottle crusher from FIG. 4.

FIG. 6 shows a third alternate embodiment of the plastic bottle crusher shown with a bottle placed inside the bottle crusher and a wrapping dispenser.

### DETAILED DESCRIPTION

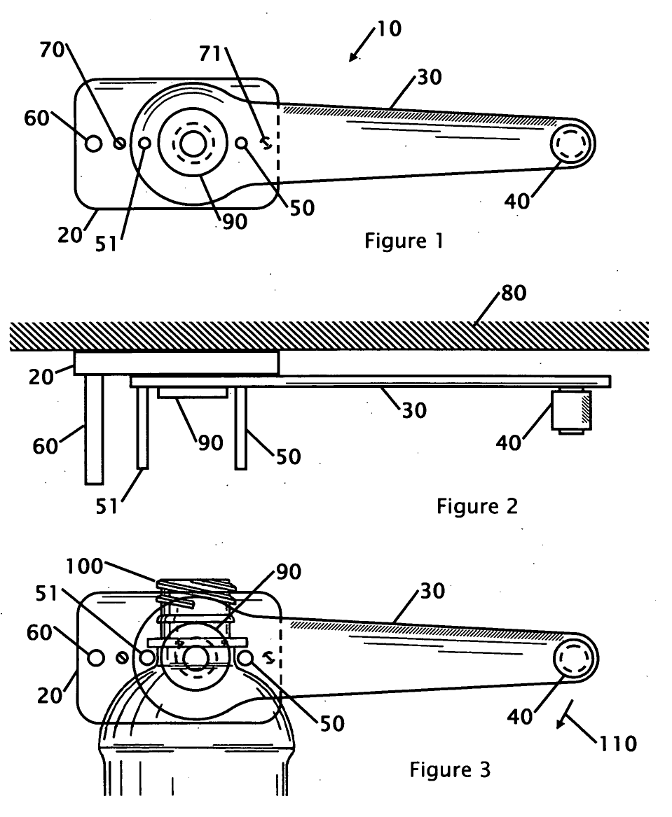

FIG. 1 shows a front view of the plastic bottle crusher. In this embodiment of the plastic bottle crusher 10, a mounting base 20 supports the mechanism. The base is essentially a flat member that is fabricated in a square, rectangular, round, oblong or elliptical in shape. The mounting base 20 is attached to a substantially flat surface such as a wall, table, cabinet or desk. Screws or other similar fasteners 70 and 71 pass through the mechanism and secure the mechanism to the wall, cabinet or table. In another contemplated method of fastening the mechanism a clamp secures the mechanism to a table, desk or other surface. The device is secured to prevent rotational movement of the device when a plastic bottle is being folded or crushed. The handle 30 is rotationally mounted to the base with a rotational coupling 90 that allows the handle to turn around the rotational coupling on the mounting base 20. While a variety of bushings, bearings or other low frictional couplings are contemplated, working units have been fabricated where no bearing is incorporated and the base and handle are constructed from similar materials.

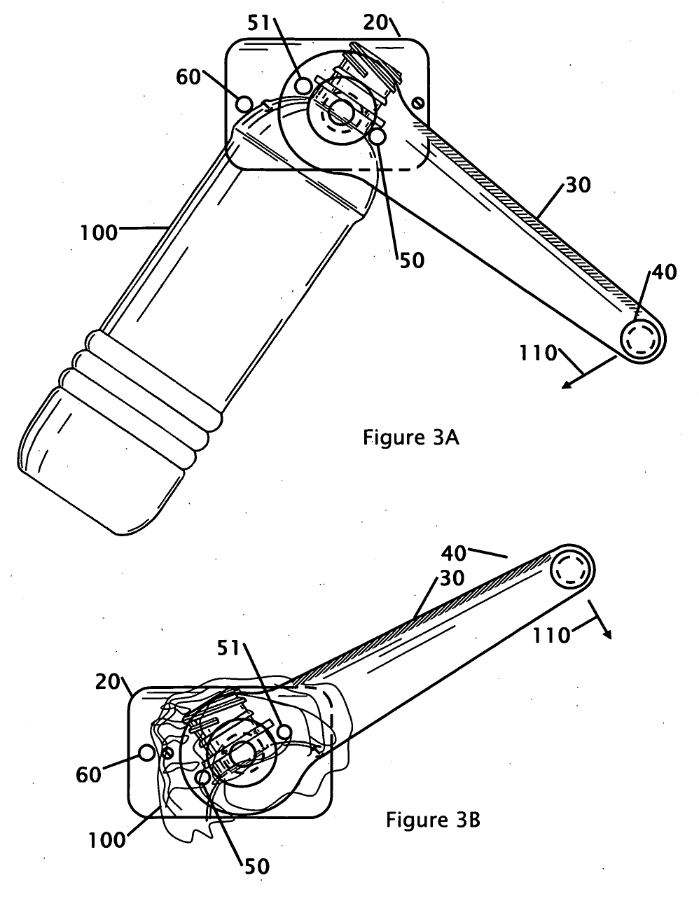

In the prototypes that have been fabricated the material used in a metal such as aluminum, but other materials are contemplated including but not limited to ferrous metals, brass, copper stainless steel as well as having the parts molded and assembled into the mechanism. Some contemplated plastic materials provide both the structural strength and the lubricity to allow the mechanism to be molded or machined from the a common material. The end of the handle 30 has a cylindrical sleeve that rotates when the handle is being turned around on the base 20. The cylindrical sleeve 40 makes rotational operation of the mechanism easier, but the rotational cylindrical sleeve or spindle 40 is not a necessary component to make the mechanism crush plastic bottles. A plastic bottle is placed into the mechanism, the plastic bottle is frictionally interference fit between two bottle holding pegs 50 and 51 that are securely mounted onto the handle mechanism 30. When the handle 30 is being turned these pegs 50 and 51 rotate the bottle where it makes contact with peg 60 that is attached to the mounting base 20. The pegs hold the bottle in the area below the top and above the body of the bottle. This location is generally the same universal size and shape regardless of the volume of fluid contained in the bottle. As the handle is further rotated the bottle is folded and crushed by the peg 60. While it is preferred that a single round crushing peg 60 is used, it is contemplated that more than one peg can be utilized as well as using a peg that is square, rectangular, elliptical or other shaped. The folding and crushing operation is shown and described in more detail in FIGS. 3, 3A and 3B.

FIG. 2 shows a top view of the plastic bottle crusher from FIG. 1. The base 20 of the plastic bottle crusher is shown secured to a wall 80 or other essentially flat structure. Placement of the plastic bottle crusher on a wall is ideal because it provides a secure solid mounting surface. Locating the mechanism on a vertical wall also provides the benefit of placing the mechanism in a location where it is out of the way but also available when needed. The handle 30 is shown adjacent to the mounting base where it is rotationally secured to the base with a bearing 90. As previously disclosed various types of bushings or bearings are contemplated, but operational prototypes have been fabricated without the use of a bearing, while still providing the rotational coupling function. At the end of the handle a cylindrical sleeve or spindle 40 makes rotational operation of the mechanism easier, but the rotational cylindrical sleeve 40 is not a necessary component to make the mechanism crush plastic bottles. The two bottle holding pegs 50 and 51 are shown mounted onto the handle mechanism 30. The crushing peg 60 is shown mounted to the base 20.

FIG. 3 shows a front view of the plastic bottle crusher from FIG. 1 with a bottle installed in the crusher. The plastic bottle 100 is being held in the mechanism with frictional interference fit between two bottle holding pegs 50 and 51. While the preferred embodiment is to hold the bottle with two round pegs, it is contemplated that more than two pegs can be utilized as well as the used of square, rectangular, elliptical or other shaped pegs can be utilized. The bottle is shown in an empty configuration with the cap removed. While the mechanism could be used with a bottle having some amount of fluid inside, as well as with the cap installed, the presence of fluid and or a cap will increase the amount of force required to crush the bottle because the pressure within the bottle would resist the crushing operation. Because of the aforementioned reason the preferred method of utilizing the mechanism is with an empty container.

Under normal operation of the mechanism the cap is removed from the bottle prior to inserting the bottle into the mechanism and commencing the crushing operation. With the bottle installed within the mechanism the handle 30 is rotated in the direction of the arrow 110. While in this example the rotational direction is shown as clockwise, the mechanism could be rotated counter-clockwise resulting in a similarly crushed bottle. The base 20 holds the mechanism securely to a wall, cabinet, desk or table while the handle 30 is being rotated on the center pivot 90. The gripper end 40 is shown where a person holds the end of the handle 30 as they crush the bottle. The crushing peg 60 is shown mounted to the base 20. As the handle is rotated in the mechanism, the bottle turns until the bottle makes contact with the crushing peg 60. This is shown and further described in FIGS. 3A and 3B.

FIG. 3A shows a front view of the plastic bottle crusher from FIG. 3 with the bottle in the initial stages of being crushed. The mounting base 20 in this figure is shown in the same orientation as shown in FIGS. 1-3. The handle is shown rotated further clockwise 110 and one side of the bottle 100 is making contact with the crushing peg 60. The bottle is still shown secured between retaining pegs 50 and 51. The gripper end 40 is shown where a person holds the end of the handle 30 as they crush the bottle. In this figure little or no deformation in the shape of the bottle is shown, but as the bottle is rotated further clockwise 110 with the handle 30 the crushing peg 60 folds the bottle onto itself. This folding is shown and described in more detail in FIG. 3B.

FIG. 3B shows a front view of the plastic bottle crusher from FIG. 3 with the bottle nearly completely crushed. The handle 30 is shown rotated about 270 degrees from the position shown in FIG. 3A. The mounting base 20 in this figure is shown in the same orientation as shown in FIGS. 1-3 and 3A. The gripper end 40 is shown where a person holds the end of the handle 30 as they crush the bottle. The bottle is still shown secured between retaining pegs 50 and 51 but the shape of the bottle is significantly compromise to a condition where the bottle is essentially folded upon itself. The crushing peg 60 is still shown in contact with a portion of the bottle 100. The handle 100 can be further rotated 110 until the end of the bottle passes past the crushing peg 60 and the bottle is removed from the mechanism where it exists in a condition significantly smaller in volume from its initial size.

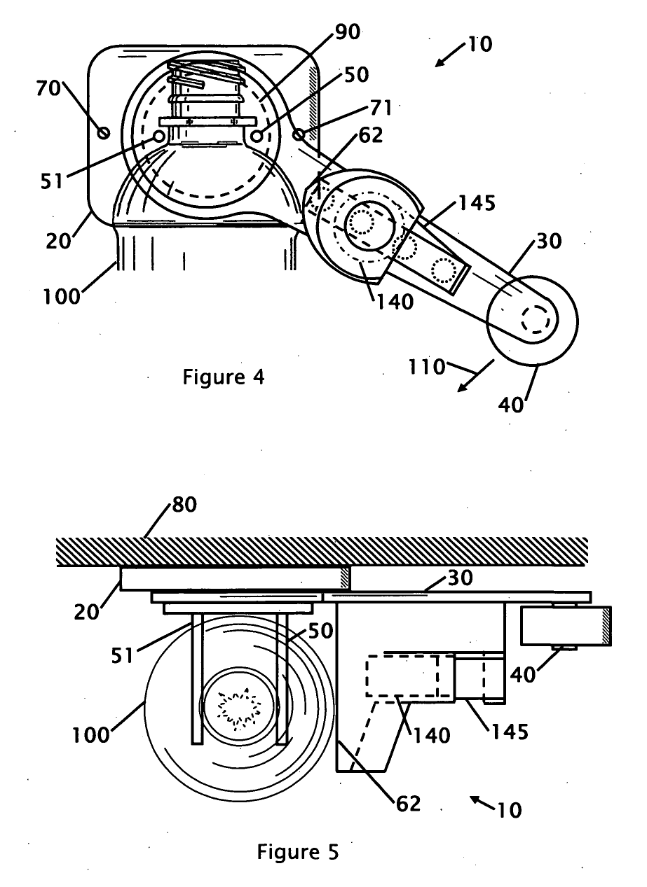

FIG. 4 shows a second alternate embodiment of the plastic bottle crusher shown with the bottle placed inside the bottle crusher. The mounting base 20 is attached to a substantially flat surface such as a wall, cabinet, table or desk. Screws or other similar fasteners 70 and 71 pass through the mechanism and secure the mechanism to the wall, cabinet or table. In this embodiment, the bottle 100 is held in position in the mechanism 10 with a frictionally interference fit between the two bottle holding pegs 50 and 51. The bottle wrapping member 62 incorporates a tape dispenser showing a roll of tape 140 mounted onto the handle 30. The tip of the bottle wrapper 62 is curved to slide over the side wall of the bottle as it is being wrapped. The handle rotates the wrapping member 62 around the fixed bottle 100 and essentially wraps the bottle around itself when the handle is turned 110 clockwise. The handle 30 could also be rotated counter-clockwise resulting in a similarly crushed bottle. The handle 30 is rotationally mounted to the base with a rotational coupling 90 that allows the handle to turn around the coupling on the mounting base 20. While a variety of bushings, bearings or other low frictional couplings are contemplated, working units have been fabricated where no bearing is incorporated and the base and handle are constructed from similar materials. After the bottle has been wrapped, tape 145 from the tape dispenser is removed from the dispenser and wrapped around the bottle to keep the bottle in a tightly wrapped configuration.

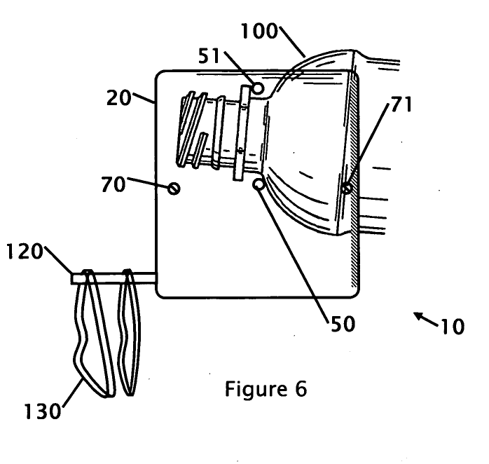

FIG. 5 shows a top view of the plastic bottle crusher 10 from FIG. 4. The base 20 of the plastic bottle crusher is shown secured to a wall 80 or other essentially flat structure. The handle 30 is shown adjacent to the mounting base where it is rotationally secured to the base. At the end of the handle a cylindrical sleeve or spindle 40 makes rotational operation of the mechanism easier. The two bottle holding pegs 50 and 51 are shown mounted onto the base mechanism 20 that extends through the handle 30. A bottle 100 is shown retained between the two retaining pegs 50 and 51. The crushing member 62, tape roll 140 and the strip of tape 145 extending from the roll is shown mounted to the handle 30.

FIG. 6 shows a third alternate embodiment of the plastic bottle crusher shown with a bottle placed inside the bottle crusher and a wrapping dispenser 10. This is the simplest embodiment contemplated where the mechanism has no moving parts. The mounting base 20 is attached to a substantially flat surface such as a wall, cabinet, table or desk. Screws or other similar fasteners 70 and 71 pass through the mechanism and secure the mechanism to the wall, cabinet or table. In another contemplated method of fastening the mechanism a clamp secures the mechanism to a table desk or other surface. The device is secured to prevent rotational movement of the device when a plastic bottle is being folded or crushed. A plastic bottle is placed into the mechanism, the plastic bottle is frictionally interference fit between two bottle holding pegs 50 and 51 that are securely mounted to the mounting base 20. In this embodiment shown the pegs place the bottle in a horizontal orientation, but vertical as well as other orientations are contemplated. In operation the bottle is place into the mechanism and the bottle is manually rotated either clockwise or counter clockwise, twisting the bottle around the holding pegs 50 and 51 until the bottle is folded into a smaller size. A peg 120 holds wrapping bands, tape or material 130. This material is dispensed from the holder, is placed around the crushed bottle, and the bottle is stored for recycling. Other dispensers are contemplated including but not limited to tape, bands, ribbon or wire.

The size and shape of the bottle can be from a 12 ounce or smaller sized drinking bottle to 2 liter or larger sized bottle. Regardless of the size of the bottle being crushed or folded, the mechanism can be appropriately sized to accommodate the bottle.

Thus, specific embodiments of a plastic bottle crusher have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A plastic bottle crusher comprising:
a mounting base for mounting a plastic bottle crusher onto a substantially flat surface;
at least two posts mounted to the base for holding a plastic bottle;
a handle rotationally mounted to the mounting base having an appendage that when rotated about the mounting base the appendage folds the plastic bottle into a smaller size.

2. The plastic bottle crusher from claim 1 wherein the bottle crusher is made from metal and or plastic.

3. The plastic bottle crusher from claim 1 wherein the end of the handle further includes a rotational spindle that allows the turns as the handle is rotated about the mounting base.

4. The plastic bottle crusher from claim 1 wherein the mounting base further includes holes for fastening the base onto the substantially flat surface.

5. The plastic bottle crusher from claim 1 wherein the base is essentially square, rectangular, round, oblong or elliptical in shape.

6. The plastic bottle crusher from claim 1 wherein the placement of the plastic bottle between the at least two posts creates a frictional fit between the at least two posts and the bottle that is sufficient to hold the plastic bottle.

7. The plastic bottle crusher from claim 1 that further includes a band, tape or wrapping material to maintain the folded plastic bottle in the folded orientation.

8. A plastic bottle crusher comprising:
a mounting base for mounting a plastic bottle crusher onto a substantially flat surface
at least one appendage that extends from the mounting base in an essentially perpendicular orientation;
a handle rotationally mounted to the base having two posts for holding a plastic bottle, wherein
when the handle is rotated about the mounting base the appendage folds the plastic bottle into a smaller size.

9. The plastic bottle crusher from claim 8 wherein the bottle crusher is made from metal and or plastic.

10. The plastic bottle crusher from claim 8 wherein the end of the handle further includes a rotational spindle that allows the turns as the handle is rotated about the mounting base.

11. The plastic bottle crusher from claim 8 wherein the mounting base further includes holes for fastening the base onto the substantially flat surface.

12. The plastic bottle crusher from claim 8 wherein the base is essentially square, rectangular, round, oblong or elliptical in shape.

13. The plastic bottle crusher from claim 8 wherein the placement of the plastic bottle between the at least two posts creates a frictional fit between the at least two posts and the bottle that is sufficient to hold the plastic bottle.

14. The plastic bottle crusher from claim 8 that further includes a band, tape or wrapping material to maintain the folded plastic bottle in the folded orientation.

15. A plastic bottle crusher comprising:
a mounting base for mounting a plastic bottle crusher onto a substantially flat surface;
at least two posts mounted to the base that extend essentially perpendicular from the mounting base for holding a plastic bottle such that when a plastic bottle is placed between the at least two posts a person can manually rotate the plastic bottle about the at least two posts to fold the plastic bottle into a smaller size.

16. The plastic bottle crusher from claim 15 wherein the bottle crusher is made from metal and or plastic.

17. The plastic bottle crusher from claim 15 wherein the mounting base further includes holes for fastening the base onto the substantially flat surface.

18. The plastic bottle crusher from claim 15 wherein the base is essentially square, rectangular, round, oblong or elliptical in shape.

19. The plastic bottle crusher from claim 15 wherein the placement of the plastic bottle between the at least two posts creates a frictional fit between the at least two posts and the bottle that is sufficient to hold the plastic bottle.

20. The plastic bottle crusher from claim 15 that further includes a band, tape or wrapping material to maintain the folded plastic bottle in the folded orientation.
